(19) United States
(12) Patent Application Publication
(10) Pub. No.: US 2007/0144562 A1
(43) Pub. Date: Jun. 28, 2007

(54) Household appliance with a part which can be moved by a handle and handle

(75) Inventors: Egbert Classen, Wertingen (DE); Gerhard Egger, Altenmuenster (DE); Bernd Schessl, Dillingen/Donau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/642,567

(22) Filed: Dec. 19, 2006

(30) Foreign Application Priority Data
Dec. 23, 2005 (DE) 10 2005 061 802.2

(51) Int. Cl. B08B 3/00

(52) U.S. Cl. 134/57 DL; 134/56 D; 134/58 D; 134/58 DL

(57) ABSTRACT

A household appliance, in particular a domestic dishwasher machine, provided with a handle (2) and a part (1) which can be moved by the handle (2) is described, said part having a fastening means (13, 19, 20) whereby the handle (2) can be releasably connected to the movable part (1). The fixing means (13, 19, 20) is arranged and embodied in such a manner that the handle width of a handle (2) to be connected to the movable part (1) is variable.

The invention relates to a household appliance, in particular a dishwasher machine, provided with a handle and part which can be moved by the handle, said part having a fastening means whereby the handle can be releasably connected to the movable part.

Household appliances, such as dishwasher machines and baking ovens, for example, have recently frequently been fitted with bow-type handles. Appliances of one manufacturer are frequently provided with identical handles to ensure that the electrical appliances are visually matched. For aesthetic reasons, there is a requirement on the part on the customer to fit household appliances with different handles matched to the kitchen surroundings.

A plurality of different technologies are known from the prior art as to the manner in which handles can be secured to a base body, a door or a drawer.

Known from DE 1 265 939 is a furniture fitting, in particular a door and drawer handle which is affixed to the base body by means of two mounting screws. The heads of the mounting screws lie in a slot on the underside of the fitting. The slot in arranged in a slide rail which is inserted in the hollow underplate of the fitting in a recessed manner, an insertion opening for the screw heads being arranged at the centre of the slot. The furniture fitting disclosed in this document has the advantage, that the mounting is very universal as a result of the spacing of the two mounting screws being continuously flexibly adjustable. A disadvantage however is the slide rail which is absolutely essential and impairs the visual appearance. This type of furniture fitting is therefore not suitable for matching the design to an existing environment.

Another handle for attaching to a door by means of fixing bolts is known from DE 1 127 246. For the purposes of attachment, the handle can be adjusted to match the distance between the holes in a door or a drawer so that it is not necessary to search for a specific size of design of such a handle. For this purpose the handle provides a displaceable elongated plate with an adjacent row of through-holes for selectively receiving a fixing bolt for a handle end, an additional spring being disposed in a recess in the handle between the plate and the handle. A disadvantage with the handle described in this document is that the handle must be mounted on the double end stub from the back of the base body.

Handles designed in two parts are known from DE 296 03 719 U1 and DE 201 00 731 U1. In this case, the handle comprises a handle rod which is connected to two handle pedestals forming the handle ends. The handle pedestals for their part are firmly connected to the base body. The handle pedestals are each fastened to the base body by means of screw connection. Whereas in DE 296 03 719 U1, the handle pedestal is fastened from the front of the base body, and a faced join is then made with the handle rod, in DE 201 00 731 U1 it is provided to first join the handle pedestals to the handle rod using a screw connection. Each screw end has an internal thread in which a further screw disposed from the back of the base body can be turned to fasten the two-part handle on the base body. A disadvantage here is the connection of the handle from the back of the base body.

DE 196 24 601 C1 describes a handle for fixing onto glass or ceramic surfaces by means of an adapter which is connected to the base support using an adhesive joint. The adhesion should avoid holes in the fixing surface. As a result of the adhesion, the force during actuation of the handle or the associated door or drawer is transferred directly to the surface connected to the adapter piece. In the case of dishwasher machines whose visible surface usually consists of relatively easily deformed plastic in the area of the handle, this could possibly result in damage to the surface of the door.

DE 36 44 021 C2 describes a household appliance, in particular a baking oven having a part which can be moved by a handle. The one-part handle is placed on a fastening element connected to the movable part and is connected thereto. However, this arrangement allows no variation in the width of the handle.

It is therefore the object of the present invention to provide a household appliance which allows a handle to be adapted to the surroundings of the kitchen of the household appliance. A further object is to provide a handle which can be variably fixed to the movable part.

These objects are achieved with a household appliance having the features of claim 1 and a handle having the features of claim 15. Advantageous embodiments are obtained in each case from the dependent claims.

The basic idea of the invention is to supply household appliances without a mounted handle and mount a handle (from the front) adapted to the surroundings of the household appliance. In order to be able to attach handles of different width in a household appliance, in particular a domestic dishwasher machine, provided with a handle and part which can be moved by the handle, said part having a fastening means whereby the handle can be releasably connected to the movable part, it is provided according to the invention that fixing means are arranged and embodied in such a manner that the handle width of a handle to be connected to the movable part is variable.

For visual reasons, the handle must be fixed to the movable part within a predefined area. According to a further embodiment, it is therefore provided that the handle comprises a first and a second handle end and the movable part has at least one of the fastening means assigned to the first and the second handle end in each case, whereby the handle can be releasably connected to the movable part, wherein the distance of the fastening means assigned to the first and the second handle end on the movable part can be selected between a first larger and a second smaller distance to vary the handle width of the handle. This takes into account the fact that the handle ends of a handle used in a kitchen can be located at different distances from one another according to the manufacturer. This produces a different fastening of the handle on the movable part.

In a further embodiment, recesses assigned to the first and the second handle end on or in the movable part for receiving the fastening means define the first and the second distance. Appropriately, at least one of the recesses on or in the movable part is embodied as an elongated hole with adjacent holes for receiving one of the fastening means. By this means, particularly small variations in distances for receiving the fastening means can be achieved.

In an appropriate embodiment, the fastening means is designed as a receiving pin and is mounted and held in the recess disposed in the movable part. The provision of receiving pins connected firmly to the movable part allows the handle to be fastened to the movable part particularly simply and inconspicuously.

In another appropriate embodiment, the handle can be releasably connected with a further fastening means from the front of the household appliance to the movable part, in particular the fastening means. The further fastening means can, for example, be a small screw, e.g. a grub screw, which can be screwed inconspicuously into the handle and thereby ensure a secure, firm connection to the fastening means. However, the further fastening means can also be a conventional screw with a screw head, a pin which produces a frictional contact or similar.

According to a further embodiment, the handle ends are arranged on the movable part in such a manner that the recesses provided to receive the fastening means on the movable part are covered by the handle ends. This particular embodiment allows a plurality of recesses assigned to a handle end or an elongated hole to be provided in the movable part in order to be able to vary the distance for fastening the handle. In this case, the handle ends are formed in such a manner that their width covers all the recesses provided to receive the fastening means.

In a further embodiment, it can be provided that the handle comprises a first and a second handle pedestal and a handle portion defining the handle width and the handle portion is releasably connected thereto in the area of a front end face of the handle pedestal. In other words, the handle can be constructed in two parts. In this case, the front end face of the handle pedestal is preferably adapted to the cross-section of the handle portion in order to produce a positive connection. By this means it is particularly possible to adapt the handle portions which particularly strongly influence the visual impression to the surroundings of the household appliance. In order to ensure high stability during actuation of the handle and the movable part, the handle pedestals are matched to the cross-section of the handle portion.

According to a further embodiment, the first and the second handle pedestals have at least one receptacle for receiving the fastening means. The receptacle can be designed in the form of a hole or a recess depending on whether the fastening means are embodied as receiving pins or as screws which can be screwed in from the front of the movable part.

In a further embodiment, the first distance of the fastening means is 448 mm. The second distance of the fastening means is ten to 30 mm smaller than the first distance.

According to a further embodiment, it is provided that the handle, in particular the handle portion is designed so that it can be lengthened in a telescopic manner. As a result, no particular measures need to be provided at the handle ends or, if the handle is constructed in two parts, at the handle pedestals. The telescopic lengthening can be made in particular in the area of the handle pedestals since visual overlapping of the multipart handle portion is possible here.

The movable part is preferably designed as a door of a dishwasher machine in which the handle is arranged in the area of a trim enclosing control and/or display elements. However, it is feasible however that the operable part is embodied as a door of a baking oven or any drawer of a household appliance.

The same advantages as have been described in connection with the household appliance according to the invention are associated with the handle according to the invention.

A handle according to the invention for releasable fastening to a movable part of a household appliance, wherein the fastening of the handle is made using a fastening means is characterised in that the handle width of the handle is variable.

According to a preferred embodiment, the handle comprises a first and a second handle end to which at least one fastening means is assigned in each case, whereby the handle can be releasably connected to the movable part, wherein the distance of the fastening means assigned to the first and the second handle end on the movable part can be selected between a first larger and a second smaller distance to vary the handle width of the handle.

Appropriately, the handle can be releasably connected with a further fastening means from the front of the household appliance to the movable part, in particular the fastening means. This can optionally be effected by using another fastening means which is brought into operative connection with the fastening means.

In a further embodiment, the handle comprises a first and a second handle pedestal and a handle portion defining the handle width, the handle portion being releasably connected thereto in the area of a front end face of the handle pedestal. The multipart configuration of the handle results in a particularly simple and convenient mounting on the movable part. In addition, the design freedom with regard to the width of the handle to be achieved is increased. This particularly relates to the distance of the fastening means assigned to the first and the second handle end. In particular, the multipart property means that the handle pedestals, for example can be provided by the manufacturer of the household appliance whereas the handle portion which substantially influences the design is provided by the manufacturer of the household appliance surroundings e.g. the kitchen manufacturer.

According to a further appropriate embodiment, the front end face of the handle pedestal is adapted to the cross-section of the handle portion in order to produce a positive connection. As a result, on the one hand, a particularly good mechanical fastening of handle portion and handle pedestals can be achieved and on the other hand, a particularly high-quality handle design is obtained.

Appropriately, the first and the second handle pedestals have at least one receptacle for receiving the fastening means. As a result, it possible in particular to fasten the handle pedestal separately from the handle portion on the movable part and only make the connection between the handle portion and the handle pedestals at a later time.

The first distance of the receptacle is preferably 480 mm and more preferably, the second distance of the receptacles is 10 to 30 mm shorter than the first distance. This ensures that the handle ends or handle pedestals of the handle visually cover the receptacles for the fastening means provided in the movable part regardless of whether these are used or not.

In a further embodiment it is provided that the handle, in particular the handle portion is designed so that it can be lengthened in a telescopic manner.

The invention is explained in detail hereinafter with reference to the figures. In the figures:

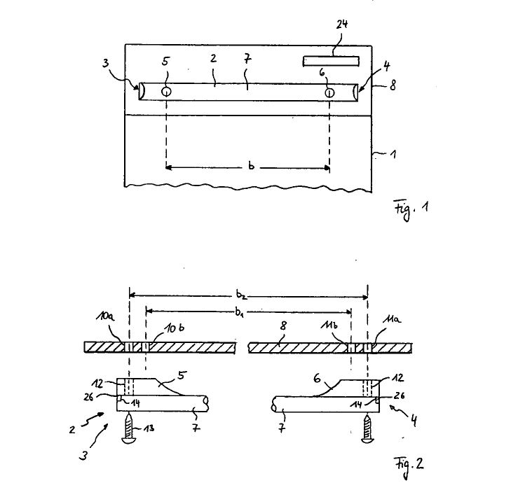

FIG. 1 is a front view of a door of a dishwasher machine and the arrangement of a handle thereon,

FIG. 2 is a section through a plan view of a movable part from which a first fastening possibility for a handle is deduced,

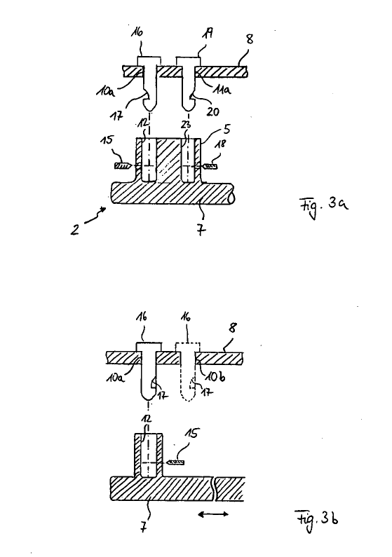

FIG. 3a, 3b is a section through a movable part from which the fastening of a handle is deduced in further variants,

FIG. 4 show various cross-sectional profiles of handle portions of a handle,

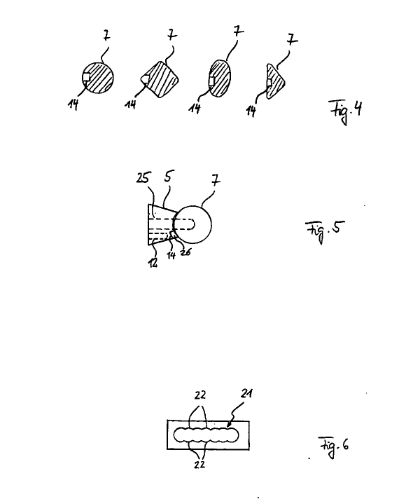

FIG. 5 is a side view of a handle pedestal and a handle portion adapted thereto and

FIG. 6 shows the embodiment of a receptacle in the movable part as an elongated hole.

FIG. 1 shows the typical arrangement of a handle 2 on a door comprising a movable part of a dishwasher machine 1. The door 1 of the dishwasher machine usually has a trim 8, in its upper section, usually comprising a plastic or occasionally comprising a metal. Control and/or display elements 24 are integrated in the area of the trim 8. For easy actuation of the door the handle 2 is embodied as bowed. The handle 2 has handle ends 3, 4. The handle is connected to the door, i.e. a fastening portion arranged behind the trim 8 in the area of these handle ends 3, 4. The handle is constructed in two parts, for example, and comprises a handle rod 7 and handle pedestals 5, 6 which form the handle ends 3, 4 of the handle 2. The handle is fastened by means of the handle pedestals 5, 6, the distance between the fastening means (not visible in FIG. 1) assigned to the handle ends 3, 4 being defined as the distance b. The distance b is also designated as the handle width.

Various possibilities for mounting a handle of variable width b on the door of a dishwasher machine and shown in FIGS. 2 and 3a, 3b.

Different handle widths b must be provided when fixing the handle ends in order to ensure variability of the handles to be affixed to the door. This variability can be provided by allocating a plurality of recesses 10a, 10b or 11a, 11b in the trim 8 to one handle end 3, 4. By this means the handle pedestal 5 as shown in FIG. 2 can be fixed in one of the recesses 10a, 10b using a fastening means 13 which is embodied in the exemplary embodiment in the form of a screw which can be screwed in from the front side. The end face of the handle pedestal 5 allocated to the trim 8 is designed in such a manner that the recess not receiving a fastening means is covered.

The handle 2 is not fastened directly to the trim 8 shown in the figure but to a bearing part located behind the trim 8 into which the force during actuation of the door can be introduced. In the exemplary embodiment shown in FIG. 2 the fastening is made using a screw which is passed below the handle portion 7 and guided through a receptacle 12 in the handle pedestal 5 and the recess 10a and connects the handle pedestal 5 non-positively and positively to the door 1.

The connection between the handle pedestal 5 and the handle portion 7 can be made using a further fastening means, e.g. a grub screw (not shown) on the underside which is barely visible for the user. In this case, it can initially be advantageous to first fix the handle portion 7 to the pedestal 5. This can be accomplished by providing a groove 14 and a projection 26 formed accordingly as a mating piece. The groove 14 can either be provided in the handle portion 7 or the pedestal 5 and the handle pedestal 6, in which case the projection can then be formed on the handle portion 7. A reversed arrangement is also feasible in a corresponding fashion.

In the exemplary embodiment according to FIG. 5 the groove 14 can furthermore be seen in the handle pedestal 5 in which the projection 26 of the handle portion 7 engages for preliminary fixing. The fastening of handle pedestal 5 and handle portion 7 can be made invisibly by inserting a fastening means, e.g. a screw (not shown) in a recess 25. The handle 2 is fastened in the manner described above by inserting a fastening means, a receiving pin or a screw into the receptacle 12 and optionally fixing with a further fastening means.

By providing two receptacles 10a, 10b or 11a, 11b, it is possible to have precisely two different distances b1, b2 at which the first and second handle ends can be affixed to the door (FIG. 2). A greater variability is provided if, instead of a plurality of separate recesses, one elongated hole 21 assigned to each handle end and having a plurality of adjacent through-holes (holes 22) is provided. This results in a number of possible distances for fixing the handles to the door corresponding to the number of adjacent through-holes 22. This is shown in FIG. 6.

FIGS. 3a and 3b show further exemplary embodiments of various possibilities for fastening the handle to the door of the household appliance. In this case, according to the exemplary embodiment shown in FIG. 3a, it is provided to arrange a fastening means 16, 19 in the form of receiving pins in each of the recesses 10a, 10b. Accordingly, the handle 2 or the handle pedestal 3 has two allocated receptacles 12, 23 which are designed to receive the receiving pins 16, 19. The receiving pins 16, 19 are each provided with undercuts 17, 20 in which further fastening means 15, 18 can engage, e.g. in the form of grub screws which pass through the walls of the receptacles 12, 23 (not shown). This ensures a secure fixing of the handle or the handle pedestal with the receiving pin which is almost invisible to the user. Unlike the drawing shown in FIG. 3a, it is also feasible to provide optionally only one receiving pin either in the recess 10a or the recess 10b for fixing the handle 2 or the handle pedestal 5.

In a further exemplary embodiment according to FIG. 3b, two separate recesses 10a, 10b are provided in the trim 8 in which optionally one single receiving pin 17 can be located. The configuration and the fastening of the receiving pin 17 with the handle 2 is carried out in the manner described in conjunction with FIG. 3a. In this exemplary embodiment, the handle portion 7 is designed so that it can be lengthened in a telescopic manner (see arrow) in order to produce the distance defined by the use of one of the receptacles 10a, 10b.

Adapting the handle to the surroundings of the household appliance in particular requires adapting the cross-section of the handle portion 7 to the surroundings. Various exemplary embodiments are shown in FIG. 4. A front end face of the handle pedestal 5 is adapted to the cross-section of the handle portion 7 to ensure secure fixing of the handle portion 7 to the handle pedestal 5 (FIG. 5).

### REFERENCE LIST

1 Door (movable part)
2 Handle
3 Handle end
4 Handle end
5 Handle pedestal
6 Handle pedestal
7 Handle rod
8 Trim
10a, 10b Recess
11a, 11b Recess
12 Receptacle
13 Fastening means
14 Groove
15 Fastening means
16 Receiving pin
17 Undercut
18 Fastening means
19 Receiving pin
20 Undercut
21 Elongated hole
22 Hole
23 Receptacle
24 Control/display element
25 Receptacle
26 Projection
b, b1, b2 Distance

1-23. (canceled)

24. A household appliance comprising:
a handle; and
a component that is mountable relative to another structure of the household appliance such that the component can be moved by a force acting on the handle, the component having a fastening means for adjustably connecting the handle to the component in a manner such that a handle width of the handle as defined by the spacing between two locations at which the handle is connected to the component is adjustably variable between one handle width and another handle width that is different than the one handle width.

25. The household appliance according to claim 24, wherein the handle comprises a first and a second handle end and the component has at least one of the fastening means of the component includes respective portions each associated with a respective one of the first and second handle ends, wherein the handle width of the handle as defined by the spacing between two locations at which the handle is connected to the component is the distance between the respective portions of the fastening means associated with the first and the second handle ends on the component and this distance can be selected between a first larger distance and a second smaller distance to vary the handle width of the handle.

26. The household appliance according to claim 25 and further comprising recesses associated with the first and the second handle ends formed at a selected one of on the componentor and in the component, the recesses for receiving the fastening means and defining the first larger distance and the second smaller distance.

27. The household appliance according to claim 26, wherein at least one of the recesses is configured as an elongated hole with adjacent holes for receiving one of the portions of the fastening means.

28. The household appliance according to claim 26, wherein the fastening means includes a receiving pin mounted in a recess disposed in the component.

29. The household appliance according to claim 26, wherein the fastening means includes means for releasably connecting the handle to a portion of the component that forms a front of the household appliance.

30. The household appliance according to claim 26, wherein the handle ends are arranged on the component in such a manner that the recesses provided to receive the fastening means on the component are covered by the handle ends.

31. The household appliance according to claim 26, wherein the handle includes a first and a second handle pedestal and a handle portion defining the handle width and the handle portion is releasably connected thereto in the area of a front end face of the handle pedestal.

32. The household appliance according to claim 31, wherein the front end face of the handle pedestal is adapted to a cross-section of the handle portion in order to produce a positive connection.

33. The household appliance according to claim 31, wherein the first and the second handle pedestals have at least one receptacle for receiving the fastening means.

34. The household appliance according to claim 25, wherein the first larger distance of the fastening means is 448 mm.

35. The household appliance according to claim 25, wherein the second smaller distance of the fastening means is 10 to 30 mm smaller than the first larger distance.

36. The household appliance according to claim 24, wherein the handle can be lengthened in a telescopic manner.

37. The household appliance according to claim 24, wherein the component is designed as a door of a dishwasher machine in which the handle is arranged in a selected one of an area of a trim enclosing control and an area of a trim enclosing display elements.

38. A handle for releasable fastening to a component of a household appliance, the handle comprising:
an engagement portion for engagement by a user such that the user can apply a force to the handle to effect movement of a component movably mounted to another structure of the household appliance such that the component can be moved by a force acting on the handle; and
a pair of connecting portions spaced from one another each for connection to the component with each connecting portion being engageable by a fastening means of the component that is operable to adjustably connect the handle to the component in a manner such that a handle width of the handle as defined by the spacing between two locations at which the pair of connecting portions of the handle are connected to the component is adjustably variable between one handle width and another handle width that is different than the one handle width.

39. The handle according to claim 38, wherein the handle includes a first and a second handle end to which at least one fastening means is assigned in each case, whereby the handle can be releasably connected to the component, wherein the distance of the fastening means assigned to the first and the second handle end on the component can be selected between a first larger and a second smaller distance to vary the handle width of the handle.

40. The handle according to claim 38, wherein the handle can be releasably connected from the front of the household appliance to the component, in particular the fastening means, with a further fastening means.

41. The handle according to claim 38, wherein the handle includes a first and a second handle pedestal and a handle portion defining the handle width, and the handle portion is releasably connected thereto in the area of a front end face of the handle pedestal.

42. The handle according to claim 31, wherein the front end face of the handle pedestal is adapted to a cross-section of the handle portion in order to produce a positive connection.

43. The handle according to claim 41, wherein the first and the second handle pedestals have at least one receptacle for receiving the fastening means.

44. The handle according to claim 43, wherein the first larger distance of the fastening means is 448 mm.

45. The handle according to claim 44, wherein the second smaller distance of the fastening means is 10 to 30 mm smaller than the first larger distance.

46. The household appliance according to claim 38, wherein the handle can be lengthened in a telescopic manner.
